(19) United States
(12) Patent Application Publication
(10) Pub. No.: US 2009/0067161 A1
(43) Pub. Date: Mar. 12, 2009

(54) Cosmetic mirror

(75) Inventor: Akira Nagata, Taipei (TW)

Correspondence Address: BACON & THOMAS, PLLC, 625 SLATERS LANE, FOURTH FLOOR, ALEXANDRIA, VA, 22314-1176, US

(73) Assignee: SANYEI CORPORATION (TAIWAN) LTD., Taipei (TW)

(21) Appl. No.: 11/896,963

(22) Filed: Sep. 7, 2007

(51) Int. Cl. F21V 33/00

(52) U.S. Cl. 362/135

(57) ABSTRACT

A cosmetic mirror is provided with light-emitting elements between an upper cover or lower cover and a mirror body, so that a light source can be illuminated uniformly and concentrated on the mirror surface. The cosmetic mirror is provided with a USB port terminal. When the USB port terminal is connected to an electronic apparatus which is capable of providing a power supply, the electricity is obtained and transmitted to the light-emitting element, thereby causing the emission of light. Further, the upper cover or lower cover can be provided with a USB insertion slot terminal for being connected with other digital elements.

### BACKGROUND OF THE INVENTION

1. Field of the Invention

The present invention relates to a cosmetic mirror, and in particular to a cosmetic mirror provided with a USB interface.

2. Description of Prior Art

Current cosmetic mirror which is available in the market and provided with a light source or an illuminating structure is, for example, disclosed in Taiwan Patent Publication No. 237079. The object of this published patent application is to provide a mirror structure whereby the brightness of the light can be changed along with the illumination of an inner mirror or according to the different demands for a lighting lamp. The light source is provided within an upper cover, and the upper cover is provided with inner holes and outer holes. A lens is arranged in the corresponding inner holes and outer holes, so that the light can enter a reflecting region provided previously to generate the illumination of the light source. According to the above structure, when using the light source to illuminate, it consumes a lot of electricity. Thus, it is necessary to replace batteries frequently, which does not conform to the concept of environmental protection.

Therefore, in view of the drawbacks derived from the above conventional article, the inventor proposes the present invention to overcome the above problems based on his experience and deliberate research.

### SUMMARY OF THE INVENTION

In order to solve the drawbacks of prior art, the object of the present invention is to provide a cosmetic mirror provided with a USB port and a USB insertion slot. The USB port can be connected to an electronic apparatus that is capable of providing a power supply. The electronic apparatus refers to any apparatus which is provided with an electronic element having USB ports thereon, such as a computer, server, stereo etc. Further, the USB insertion slot can be connected to a digital element to expand its function. The digital element refers to a keyboard, mouse, PDA, mobile phone etc.

In order to achieve the above object, the present invention provides a cosmetic mirror provided with a USB port terminal and a USB insertion slot terminal. The USB port terminal is connected to an electronic apparatus which is capable of providing a power supply, so that the cosmetic mirror can be supplied with electricity from the connected electronic apparatus. In this way, the electricity can be supplied to a light-emitting element provided between an upper cover (or lower cover) and a mirror body to generate the illumination of a light source. The light-emitting element is provided on the mirror body or behind the mirror body, thereby making the light source softer and concentrating the light on the mirror surface. When the USB port terminal is connected to an electronic apparatus which is capable of providing a power supply, the electricity can be supplied to the light-emitting element to generate the illumination of the light source. Therefore, it is unnecessary to replace batteries and thus beneficial for the environmental protection. The USB insertion slot terminal provided on the cosmetic mirror is further provided with a plurality of USB insertion slots which can serve as USB expansion slots and be connected to various digital elements. Via this arrangement, in addition to the traditional functions, the cosmetic mirror of the present invention can also provide an expanding function for the digital elements.

Preferably, when the USB port terminal is connected to an electronic apparatus which is capable of providing a power supply, the electricity can be supplied to the light-emitting element to generate the illumination of the light source. The USB insertion slot terminal can be further provided with a plurality of USB insertion slots serving as USB expansion slots.

Preferably, the light-emitting element is a LED or bulb.

The above objects and structural and functional features of the present invention will be described with reference to the preferred embodiment shown in the accompanying drawings.

### BRIEF DESCRIPTION OF THE DRAWINGS

FIG. 1 is a schematic view (I) showing the structure of a preferred embodiment of the present invention;

FIG. 2 is a schematic view (II) showing the structure of the preferred embodiment of the present invention; and

FIG. 3 is a schematic view (III) showing the structure of the preferred embodiment of the present invention.

### DETAILED DESCRIPTION OF THE INVENTION

In order to further understand the other advantages, objects, technical characteristics and effects of the present invention, a detailed description related thereto will be explained with reference to preferred embodiments shown in the accompanying drawings.

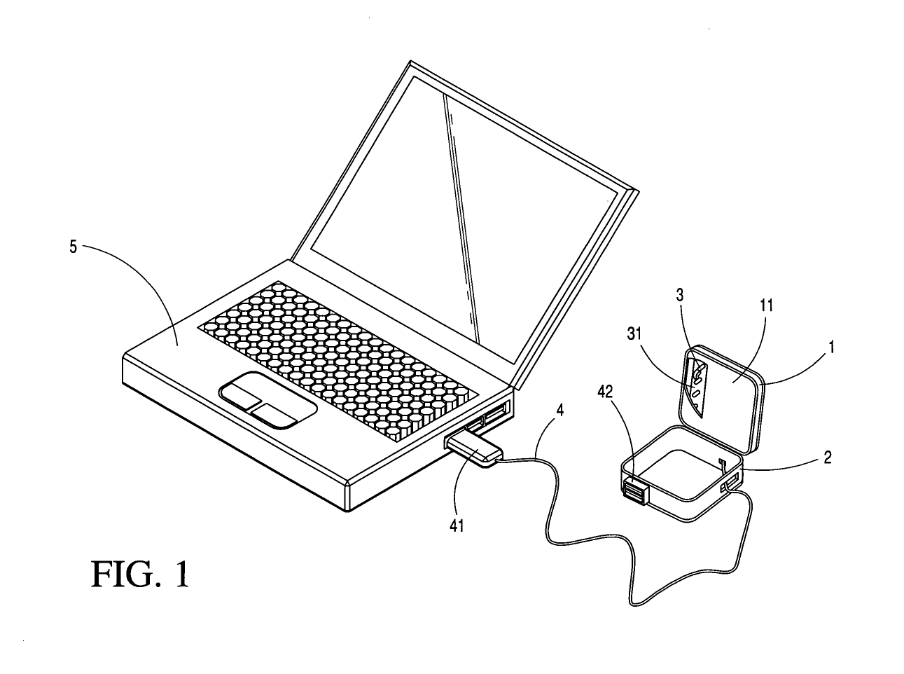

The present invention provides a cosmetic mirror. The drawings show a preferred embodiment of the present invention. With reference to FIG. 1, it is schematic view (I) showing the structure of the preferred embodiment of the present invention. The cosmetic mirror of the present invention comprises an upper cover 1, a lower cover 2, a mirror body 11, a circuit unit 31, a light-emitting element 3, and a USB port terminal 41. The circuit unit 31 is provided between the upper cover 1 and the mirror body 11. The circuit unit 31 is provided with one or a plurality of light-emitting elements 3. The electricity source of the light-emitting element 3 provided in the upper cover 1 is supplied by means of connecting the circuit unit 31 to a lead 4, connecting the lead 4 to the USB port terminal 41, and connecting the USB port terminal 41 to an electronic apparatus 5 which is capable of providing a power supply. In this way, the electricity can be supplied to the light-emitting element 3 to cause the emission of light.

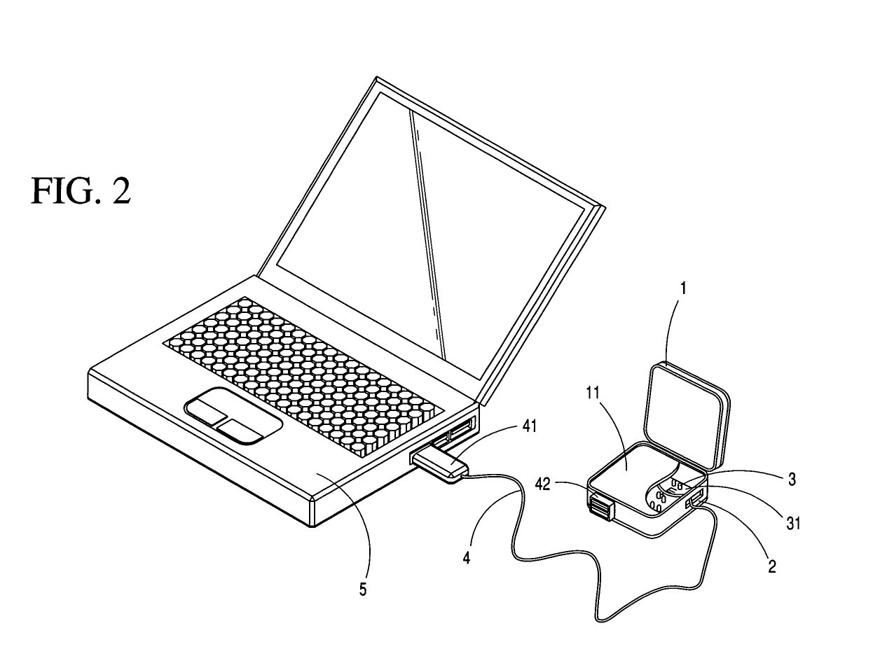

With reference to FIG. 2, it is schematic view (II) showing the structure of another preferred embodiment of the present invention. The cosmetic mirror of the present invention comprises an upper cover 1, a lower cover 2, a mirror body 11, a circuit unit 31, a light-emitting element 3, and a USB port terminal 41. The circuit unit 31 is provided between the lower cover 2 and the mirror body 11. The circuit unit 31 is provided with one or a plurality of light-emitting elements 3. The electricity source of the light-emitting element 3 provided in the lower cover 2 is supplied by means of connecting the circuit unit 31 to a lead 4, connecting the lead 4 to the USB port terminal 41, and connecting the USB port terminal 41 to an electronic apparatus which is capable of providing a power supply. In this way, the electricity can be supplied to the light-emitting element 3 to cause the emission of light.

As shown in FIG. 1 and FIG. 2, one or a plurality of light-emitting elements 3 can be provided at the insides of the upper cover 1 and the lower cover 2. The light-emitting element 3 can be a LED or bulb. With the USB port terminal 41 being connected to the electronic apparatus 5 which is capable of providing a power supply, the electricity can be obtained for the purpose of illumination when the light is insufficient. Since the light-emitting element 3 is provided behind the mirror body 11 and thus the light generated illuminates from the back of the mirror body, the light becomes softer and more concentrated.

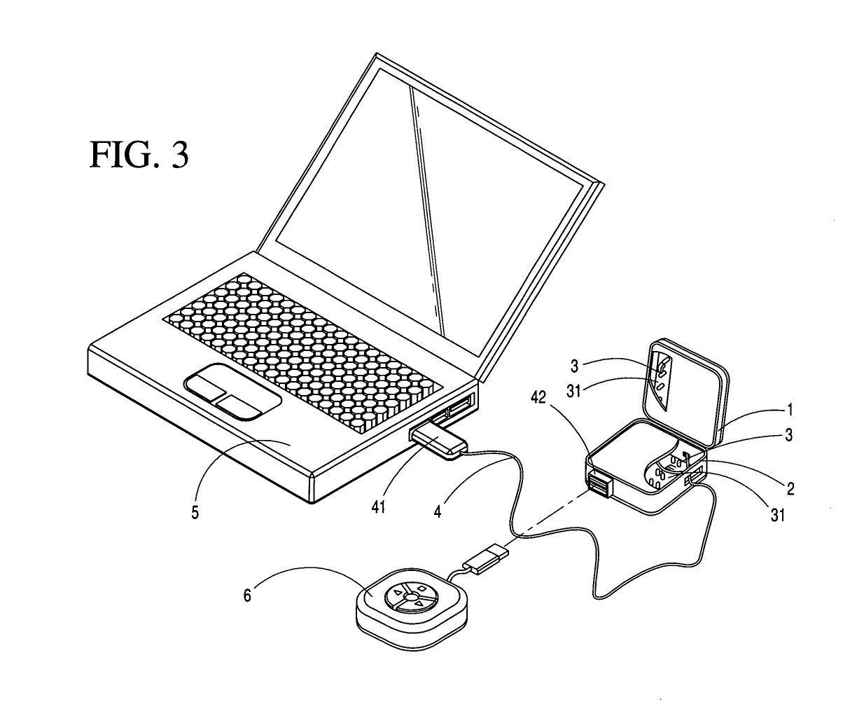

With reference to FIG. 3, it is schematic view (III) showing the structure of another preferred embodiment of the present invention. The lower cover 2 is provided with a USB insertion slot terminal 42 and a USB port terminal 41. When the USB port terminal 41 is connected to the electronic apparatus 5 which is capable of providing a power supply, the electricity can be transmitted from the USB port terminal 41 to the lead 4, and then from the lead 4 to the circuit unit 31 (as shown in FIG. 1), thereby providing the electricity for the light-emitting element 3 to cause the emission of light. Alternatively, one or a plurality of USB insertion slot terminals 42 can be provided to allow for the connection of external digital element(s) 6, thereby achieving an effect of expansion slot(s).

According to the above, the present invention has not been published or used in public prior to filing for a patent. Further, the present invention really has novelty and inventive steps and thus conforms to the requirements for a utility model patent.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A cosmetic mirror, comprising:
an upper cover provided thereon with a mirror body and a light-emitting element;
a lower cover closed with the upper cover;
a circuit element for transforming electricity and signals and being connected to the light-emitting element;
a USB port terminal connected to an electronic apparatus that is capable of providing a power supply;
wherein with the USB port terminal being connected to the electronic apparatus which is capable of providing a power supply, the electricity is obtained and transmitted to the light-emitting element via the circuit unit, thereby causing the emission of light.

2. A cosmetic mirror, comprising:
a lower cover provided thereon with a mirror body and a light-emitting element;
an upper cover closed with the lower cover;
a circuit element for transforming electricity and signals and being connected to the light-emitting element;
a USB port terminal connected to an electronic apparatus that is capable of providing a power supply;
wherein with the USB port terminal being connected to the electronic apparatus which is capable of providing a power supply, the electricity is obtained and transmitted to the light-emitting element via the circuit unit, thereby causing the emission of light.

3. The cosmetic mirror according to claim 1 or 2, wherein the upper cover is provided with a USB insertion slot terminal serving as an expansion slot.

4. The cosmetic mirror according to claim 1 or 2, wherein the lower cover is provided with a USB insertion slot terminal serving as an expansion slot.

5. The cosmetic mirror according to claim 1 or 2, wherein the light-emitting element is a LED.

6. The cosmetic mirror according to claim 1 or 2, wherein the light-emitting element is a bulb.
